(19) United States
(12) Patent Application Publication
(10) Pub. No.: US 2013/0155446 A1
(43) Pub. Date: Jun. 20, 2013

(54) IMAGE FORMING APPARATUS AND CONTROL METHOD FOR IMAGE FORMING APPARATUS

(71) Applicant: Emiko Matsuoka, Shizuoka-ken (JP)

(72) Inventor: Emiko Matsuoka, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/693,765

(22) Filed: Dec. 4, 2012

Related U.S. Application Data
(60) Provisional application No. 61/570,933, filed on Dec. 15, 2011.

(51) Int. Cl. G06K 15/02

(52) U.S. Cl. CPC G06K 15/02
USPC 358/1.14; 358/1.15

(57) ABSTRACT

An image forming apparatus comprises a recording medium conveying mechanism configured to feed a recording medium, an image forming unit configured to form an image on the fed recording medium, a communication interface configured to communicate an information with a client computer and a control unit configured to receive a command code defined by expanding an undefined command code and control a printing job in accordance with the command code defined by the expansion.

### CROSS-REFERENCE TO RELATED APPLICATIONS

This application is based upon and claims the benefit of priority from U.S. Provisional Application No. 61/570,933 filed on Dec. 15, 2011; the entire contents of which are incorporated herein by reference.

### FIELD

Embodiments described herein relate to an image forming apparatus and a control method for the image forming apparatus.

### BACKGROUND

Conventionally, when a printer is connected with a network to conduct a printing processing, a command is sent to the printer in accordance with a printer controlling protocol such as LPD (Line Printer Daemon) etc., thereby controlling the printer.

In the case where LPD protocol is used, a command code and a corresponding printer action are defined in accordance with, for example, RFC1179 standard etc., a computer carries out the defined action after receiving the command code.

However, such protocols can only define corresponding codes for limited printer actions, failing to meet a variety of user requests finely.

For example, if a job is cancelled, in RFC 1179, only one command is defined to cancel the job merely, cannot carry out the detailed processing such as cancellation the job and save the log.

Considering this, there is proposed a technique that an interface and a protocol control unit that is hardware for interpreting a plurality of protocols are set and a request that is not defined by LPD send to printer, in accordance with a protocol from LPD.

However, this technique need to set the same number of new hardwares as a protocols, so not only the costs of production rise, but also the printer is incapable of carrying out an action that protocol not supported.

### BRIEF DESCRIPTION OF THE DRAWINGS

FIG. 1 is a diagram showing the structure of an image forming apparatus;

FIG. 2 is a block diagram showing the structure of an image forming apparatus;

FIG. 3 is a diagram showing an example of a packet that is sent from a client computer to an image forming apparatus;

FIG. 4 is a diagram illustrating the association among a command code, a command name and a requested printer action;

FIG. 5 is a flowchart showing the communication condition between a client computer and an image forming apparatus in the case of a printing indication;

FIG. 6 is a flowchart showing the communication condition between a client computer and an image forming apparatus in the case of a job cancel indication;

### DETAILED DESCRIPTION

Hereinafter, the embodiment of the image forming apparatus and the control method for the image forming apparatus is described in detail with reference to drawings.

In accordance with one embodiment, an image forming apparatus comprises a recording medium conveying mechanism configured to feed a recording medium, an image forming unit configured to form an image on the fed recording medium, a communication interface configured to communicate an information with a client computer and a control unit configured to receive a command code defined by expanding an undefined command code and control a printing job in accordance with the command code defined by the expansion.

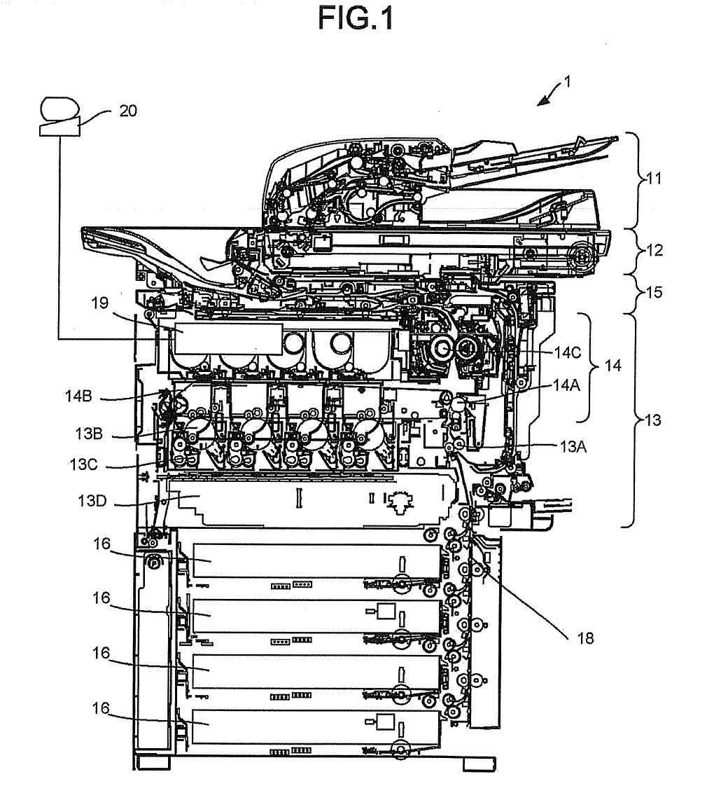

FIG. 1 is a diagram showing the structure of an image forming apparatus 1 in accordance with the embodiment. As shown in FIG. 1, the image forming apparatus 1 comprises an automatic original feeder 11, an image reading unit 12, an image forming unit 13, a paper feeding unit 16, a recording medium conveying mechanism 18 and a control unit 19.

The automatic original feeder 11 is arranged on the upper portion of the image forming apparatus 1 in such a manner that the automatic original feeder 11 can be opened or closed. The automatic original feeder 11 is provided with an original conveying mechanism for taking out, piece by piece, originals from a paper feeding tray and conveying the originals to a paper discharging tray.

With an original conveying function, the automatic original feeder 11 conveys, piece by piece, originals to the original reading unit of the image reading unit 12. Moreover, the automatic original feeder 11 may be opened to load originals onto the original table of the image reading unit 12.

The image reading unit 12 comprises: a carriage provided with an exposure lamp for exposing originals and a first reflection mirror; a plurality of second reflection mirrors acting in accordance with the action of the carriage; a lens block; and the CCD (Charge Coupled Device) of an image reading sensor.

The carriage keeps motionless on an original reading unit or reciprocates under the original table so that the light of the exposure lamp reflected by the original is reflected to the first reflection mirror. The plurality of second reflection mirrors enable the reflected light of the first reflection mirror to be reflected to the lens block. The lens bock changes the magnification of the reflected light and then outputs the reflected light to the CCD. The CCD changes incident light into an electric signal and outputs the electric signal to the image forming unit 13 as an image signal.

The image forming unit 13 has a resist roller 13A for correcting the facing direction of the recording medium so that the side of the slantwise conveyed recording medium in the width direction is parallel to the conveying direction of the recording medium.

With the use of the image forming unit 13, the image forming apparatus 1 forms an image on the recording medium the facing direction of which is corrected by the resister roller 13A.

The image forming method of the image forming unit 13, which is not limited herein, can be chosen from image forming methods of different types, for example, an electronic type, an inkjet type and etc.

In the case of the electronic type, the image forming unit 13 comprises, corresponding to Yellow Y, Magenta M, Cyan C and Black K, a laser radiation unit 13D, a photosensitive drum 13B serving as an electrostatic latent image carrier, a developer feeding unit 13C and a transfer unit 14.

The laser radiation unit 13D radiates laser beams towards the photosensitive drum 13B based on the image signal to form an electrostatic latent image on the photosensitive drum 13B. The developer feeding unit 13C feeds a developer to the photosensitive drum 13B to form a developer image using the electrostatic latent image.

The paper feeding unit 16 takes out, piece by piece, the recording medium from a paper feed cassette and conveys the recording medium to the paper conveying mechanism. The paper conveying mechanism conveys the recording medium to the transfer unit 14.

The transfer unit 14 comprises a transfer belt 14B and a transfer roller 14A. The transfer belt 14B serving as an image carrier carries the developer of the photosensitive drum 13B to accept a transfer. The transfer roller 14A applies a voltage to transfer the developer of the transfer belt onto the recording medium conveyed thereto.

The image forming apparatus 1 is provided with a fixing device 14C at the downstream of the recording medium conveying direction of the transfer unit 14. The fixing device 14C heats and applies a pressure to the developer to fix it on the recording medium.

The recording medium on which an image is formed is fed to a slip correction device 15.

In the case of the inkjet type, the image forming unit 13 is provided with a printing head for jetting ink to the recording medium.

The head comprises: an ink feeding chamber that piezoelectric elements with different polarities are attached in the length direction, wherein the groups of the attached piezoelectric elements are arranged in a comb-like; and an outer cover which is provided with an ink discharge hole and covers the ink feeding chamber.

The image forming unit 13 applies a voltage to the printing head alternatively to transform the ink feeding chamber to suck ink and jet ink from the ink jetting hole repeatedly. The ejected ink is attached on the recording medium to form an image.

The image forming apparatus 1 is connected with a client computer 20.

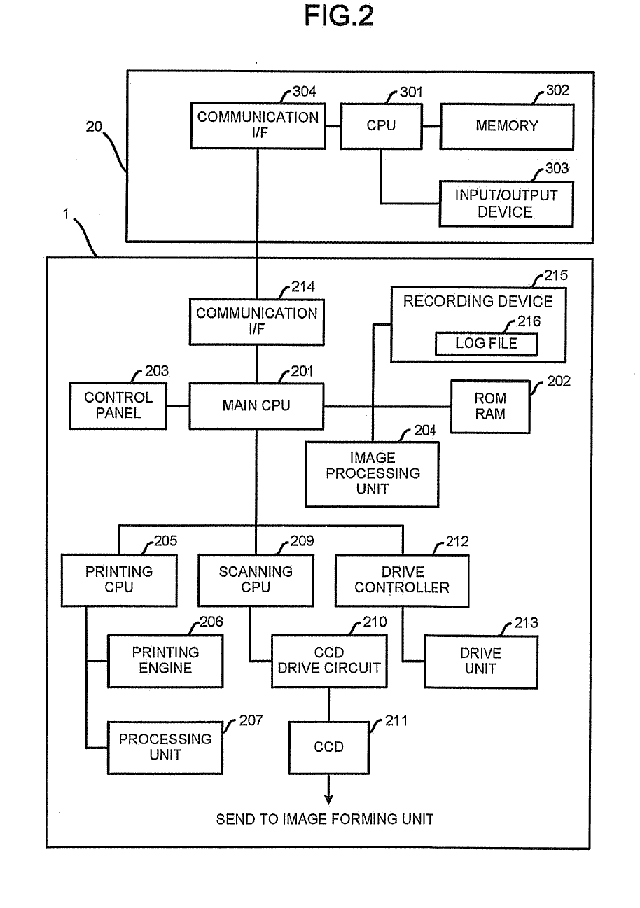

FIG. 2 is a block diagram showing the structure of the image forming apparatus 1. As shown in FIG. 2, the image forming apparatus 1 comprises: a main CPU 201 (Central Processing Unit) serving as a control unit 19 for controlling the whole image forming apparatus 1; an ROM (Read Only Memory) and an RAM (Random Access Memory) 202 serving as a memory; a recording device 215 having a log file 216; an image processing unit 204 for processing images; and a communication interface (hereinafter, “interface” is referred to as “I/F”) for conducting an information communication with an external device.

The main CPU 201 is connected with a printing CPU 205 for controlling each unit of an image forming system, a scanning CPU 209 for controlling each unit of an image reading system and a drive controller 212 for controlling a drive unit.

In the case of the electronic type, the printing CPU 205 controls: a printing engine 206 which forms an electrostatic latent image on the photosensitive drum 13B; and a processing unit 207 for forming a developer image.

The scanning CPU 209 controls a CCD drive circuit 210 for driving a CCD 211. The signal from the CCD 211 is output to the image forming unit 13.

The drive controller 212 is connected with a drive unit 213.

The client computer 20 comprises: a CPU 301 serving as an operating device; a memory 302 such as an ROM and an RAM etc.; an input/output device 303 such as a display, a keyboard and a mouse; and a communication I/F 304.

The client computer 20 is connected with the image forming apparatus 1 via a communication I/F 304 and a communication I/F 214.

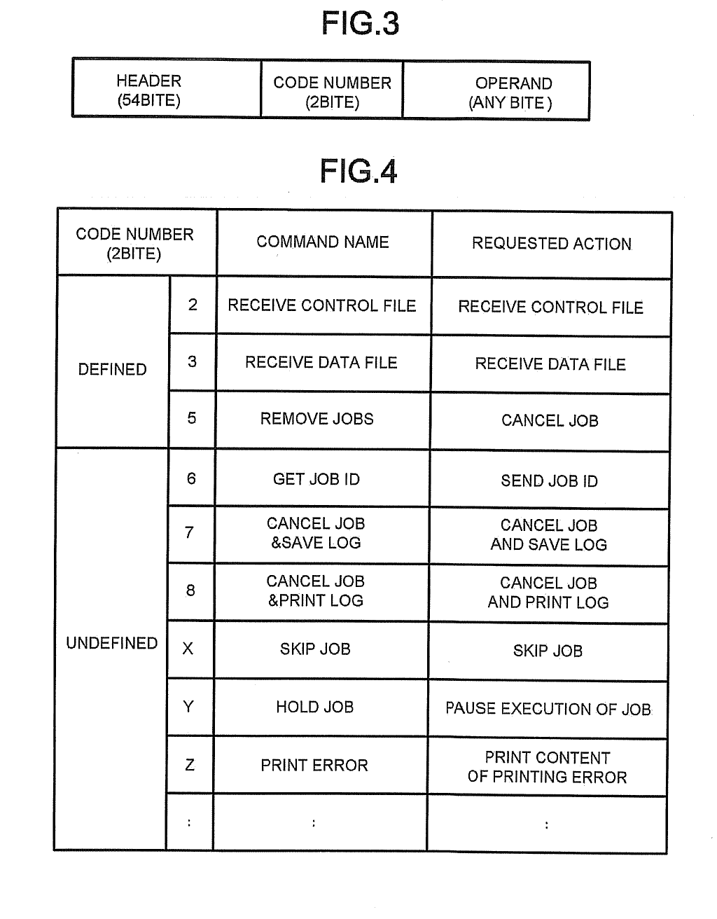

FIG. 3 is a diagram showing an example of a packet that is sent from the client computer 20 to the image forming apparatus 1. As shown in FIG. 3, for example, in LPD protocol, the front end of a packet contains a 54-byte header unit, a 2-byte command code, that is, a code number, that is next to the header unit, and an operand of any byte next to the code number.

FIG. 4 is a diagram illustrating the association between a command code and a command name used in the embodiment and a requested printer action.

In RFC 1179 of LPD protocol, for example, command codes 2, 3 and 5 are defined already.

The image forming apparatus 1 described in the embodiment expands command codes by assigning printer actions to code numbers that are not defined by RFC 1179 standard and so on, thereby meeting user requests more flexibly.

Specifically, command codes are expanded by assigning actions to undefined command codes in the following way.

(1) command code ‘6’

Command name: Get job ID

Requested action: request to send job ID

(2) command code ‘7’

Command name: Cancel job & save log

Requested action: cancel job and save log in log file 216

(3) command code ‘8’

Command name: Cancel job & print log

Requested action: cancel job and print log in log file 216

(4) command code ‘X’

Command name: skip job

Requested action: skip job

(5) command code ‘Y’

Command name: Hold job

Requested action: pause the printing of job.

(6) command code ‘Z’

Command name: Print error

Print the print error content.

In addition to the definition above, by assigning printer actions to undefined command codes, finer actions can be carried out by the printer.

Further, by expanding the operands of the defined command code, finer actions can also be carried out by the printer.

For example, in the case of ‘Cancel job’, the following operand may be defined by using command code ‘5’.

command code ‘5’

Command name: Remove jobs

Operand:
job ID: ID of the job for canceling
save log: When is ON, save log in log file 216
print log: When is ON, print log
Skip job: When is ON, skip job instead of canceling job
Pause job: When is ON, pause printing instead of canceling job
Print error: When is ON, print the print error content

Besides, actions may be assigned to the command codes undefined in the standard, and operands may be re-defined.

For example, the image forming apparatus 1 may be configured to carry out actions after receiving the following command.

command code ‘7’

Command name: Cancel job & save log

Requested action: cancel job and save log in log file 216

Operand:
print log: When is ON, furthermore print log

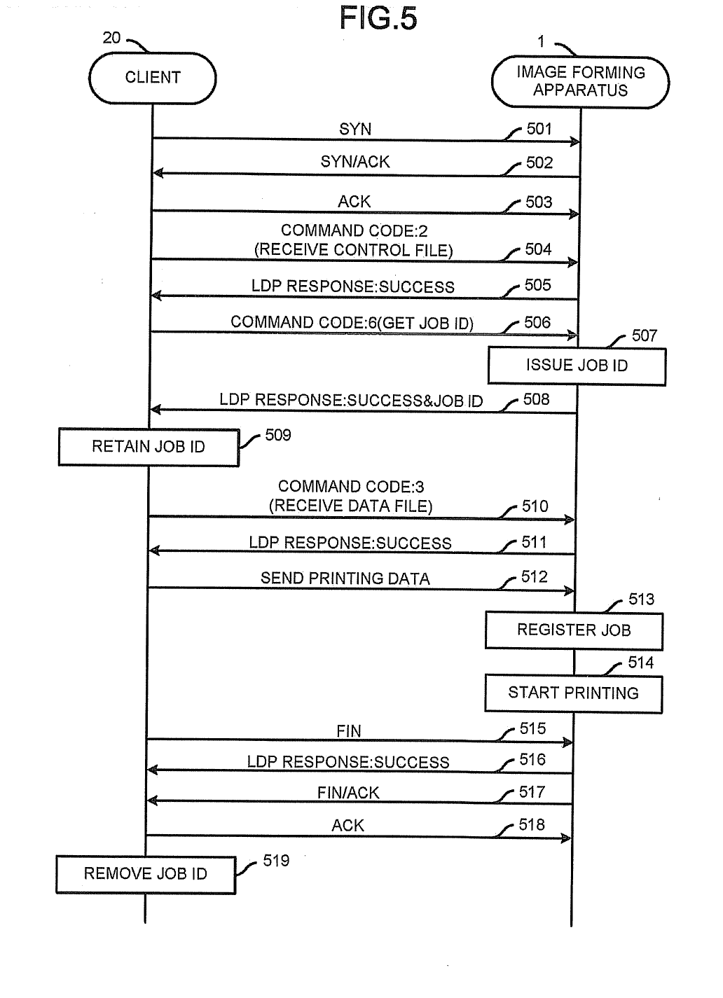

FIG. 5 is a flowchart showing the communication condition between the client computer 20 and the image forming apparatus 1 in the case of a printing indication.

As shown in FIG. 5, in Act 501, the client computer 20 sends ‘SYN’ to the image forming apparatus 1.

In Act 502, the image forming apparatus 1 sends ‘SYN/ACK’ to the client computer 20.

In Act 503, the client computer 20 sends ‘ACK’ to the image forming apparatus 1.

In Act 504, the client computer 20 sends a command code ‘2’ to the image forming apparatus 1 and sends a command file.

In Act 505, after receiving the command file, the image forming apparatus 1 sends ‘Success’ to the client computer 20 as a LPD Response.

In Act 506, the client computer 20 sends a command code ‘6’ to the image forming apparatus 1 to request the image forming apparatus 1 to send a job ID.

In Act 507: the image forming apparatus 1 issues a job ID.

In Act 508, the image forming apparatus 1 sends ‘Success’ as a LPD Response, along with the Job ID, to the client computer 20.

In Act 509: the client computer 20 saves the received job ID in the RAM 202.

In Act 510, the client computer 20 sends a command code ‘3’ to the image forming apparatus 1 and sends a data file.

In Act 511, after receiving the data file, the image forming apparatus 1 sends ‘Success’ as an LPD Response to the client computer 20.

In Act 512, the client computer 20 sends printing data to the image forming apparatus 1.

In Act 513: the image forming apparatus 1 registers a Job.

In Act 514: the image forming apparatus 1 starts printing.

In Act 515, the client computer 20 sends ‘FIN’ to the image forming apparatus 1.

In Act 516, the image forming apparatus 1 sends ‘Success’ as an LPD Response to the client computer 20.

In Act 517, the image forming apparatus 1 sends ‘FIN/ACK’ to the client computer 20.

In Act 518, the client computer 20 sends ‘ACK’ to the image forming apparatus 1.

In Act 519: the client computer 20 removes the saved job ID.

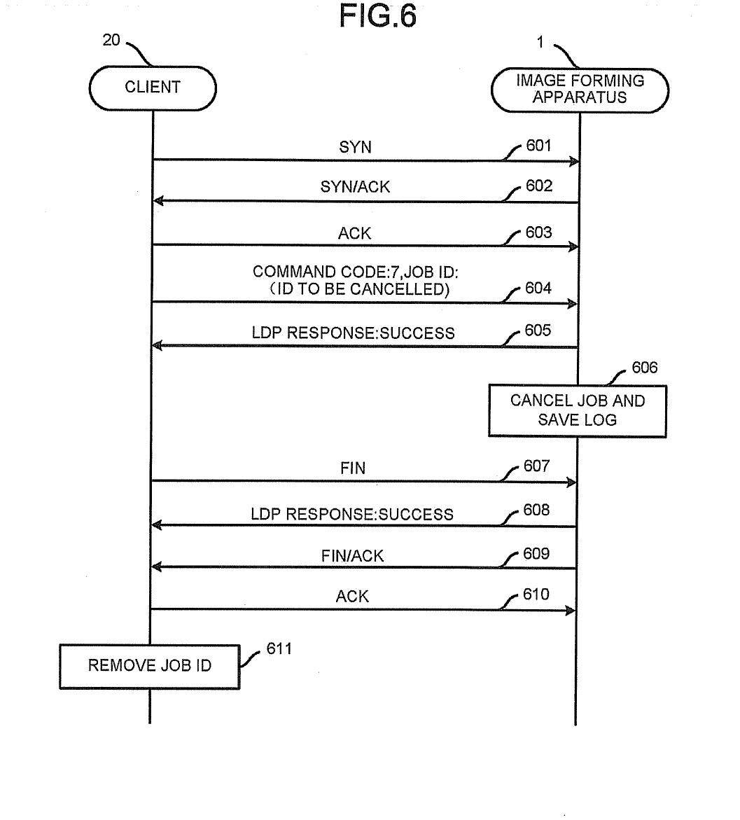

FIG. 6 is a flowchart showing the communication condition between the client computer 20 and the image forming apparatus 1 in the case of a job cancel indication.

As shown in FIG. 6, in Act 601, the client computer 20 sends ‘SYN’ to the image forming apparatus 1.

In Act 602, the image forming apparatus 1 sends ‘SYN/ACK’ to the client computer 20.

In Act 603, the client computer 20 sends ‘ACK’ to the image forming apparatus 1.

In Act 604, the client computer 20 sends a command code ‘7’ to the image forming apparatus 1 and sends a Job ID to be cancelled.

In Act 605, the image forming apparatus 1 sends ‘Success’ as an LPD Response to the client computer 20.

In Act 606: the image forming apparatus 1 cancels the job with a specified Job ID and writes a log into the log file 216.

At this time, the image forming apparatus 1 adds the name of the client program indicated by job cancel, the user name and the name of the client computer 20 in the log, and writes them in the log file 216.

Thus, by viewing the log, the manager can know which client program leads to the cancel of the job.

In Act 607, the client computer 20 sends ‘FIN’ to the image forming apparatus 1.

In Act 608, the image forming apparatus 1 sends ‘Success’ as an LPD Response to the client computer 20.

In Act 609, the image forming apparatus 1 sends ‘FIN/ACK’ to the client computer 20.

In Act 610, the client computer 20 sends ‘ACK’ to the image forming apparatus 1.

In Act 611: the client computer 20 removes the saved job ID.

As stated above, in the embodiment, the image forming apparatus 1 comprises: a recording medium conveying mechanism 18 configured to feed a recording medium; an image forming unit 13 configured to form an image on the recording medium fed; a communication I/F 214 configured to achieve an information communication with the client computer 20; and a control unit 19 configured to receive a command code defined by expanding an undefined command code and to control a printing job in accordance with the command code defined by the expansion.

Therefore, the image forming apparatus 1 and the control method for the same provided in the embodiment can flexibly carry out an action according to a user request.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a recording medium conveying mechanism configured to feed a recording medium;
an image forming unit configured to form an image on the fed recording medium;
a communication interface configured to communicate an information with a client computer; and
a control unit configured to receive a command code defined by expanding an undefined command code and control a printing job in accordance with the command code defined by the expansion.

2. The image forming apparatus according to claim 1, wherein
the command code defined by the expansion includes:
a command code indicating that the client computer requests a job ID from the image forming apparatus; and
a command code indicating that the client computer requests the image forming apparatus to cancel the job with the job ID and save a log.

3. The image forming, apparatus according to claim 2, wherein
the client computer saves the job ID received from the image forming apparatus until the job is cancelled.

4. The image forming apparatus according to claim 1, wherein
the command code defined by the expansion is further expanded with the use of an operand.

5. The image forming apparatus according to claim 4, wherein
the operand includes:
an operand indicating that the client computer requests a job ID from the image forming apparatus; and
an operand indicating that the client computer requests the image forming apparatus to cancel the job with the job ID and to save a log.

6. A control method for an image forming apparatus, comprising:
requesting, by a client computer, a job ID from the image forming apparatus in accordance with a command code defined by expanding an undefined command code;
sending, by the image forming apparatus, the job ID to the client computer in accordance with the command code defined by the expansion;
saving, by the client computer, the job ID received from the image forming apparatus;
requesting, by the client computer, the image forming apparatus to cancel the job with the job ID and to save a log in accordance with a command code defined by expanding an undefined command code;
canceling, by the image forming apparatus, the job with a specified jog ID in accordance with a command code defined by expanding; and
saving, by the image forming apparatus, the log in accordance with a command code defined by expanding.

7. The control method for an image forming apparatus according to claim 6, wherein
the command code defined by the expansion includes:
a command code indicating that the client computer requests a job ID from the image forming apparatus; and
at least one of the following command codes:
(1) an command code indicating that the client computer requests the image forming apparatus to cancel the job with the job ID and to save a log;
(2) a command code of requesting the image forming apparatus to skip a job;
(3) a command code of requesting the image forming apparatus to print the print error content.

8. The control method for an image forming apparatus according to claim 7, wherein
the client computer saves the job ID received from the image forming apparatus until the job is cancelled.

9. The control method for an image forming apparatus according to claim 6, wherein
the command code defined by the expansion is further expanded with the use of an operand.

10. The control method for an image forming apparatus according to claim 9, wherein
the operand includes:
an operand indicating that the client computer requests a job ID from the image forming apparatus; and
an operand indicating that the client computer requests the image forming apparatus to cancel the job with the job ID and to save a log.
